(19) United States
(12) Patent Application Publication
(10) Pub. No.: US 2009/0083753 A1
(43) Pub. Date: Mar. 26, 2009

(54) DYNAMIC THREAD GENERATION AND MANAGEMENT FOR IMPROVED COMPUTER PROGRAM PERFORMANCE

(75) Inventor: Yoav M. Tzruya, Even Yehuda (IL)

Correspondence Address: FIALA & WEAVER, P.L.L.C.;C/O INTELLEVATE, P.O. BOX 52050, MINNEAPOLIS, MN, 55402, US

(73) Assignee: EXENT TECHNOLOGIES, LTD., Petach-Tikva (IL)

(21) Appl. No.: 11/860,849

(22) Filed: Sep. 25, 2007

(51) Int. Cl. G06F 9/46

(52) U.S. Cl. 718/107

(57) ABSTRACT

The performance of an executing computer program is dynamically enhanced by creating one or more additional threads of execution and then intercepting function calls generated by the executing computer program and executing such function calls within one of the one or more additional threads. Each thread may be associated with a different processing resource, thereby allowing for concurrent execution of the multiple threads. This technique may be used, for example, to improve the performance of a single-threaded computer program, such as a single-threaded video game program, by allowing multi-threaded techniques to be used to execute the computer program even though the computer program was not designed to use such techniques.

### BACKGROUND OF THE INVENTION

1. Field of the Invention

The invention generally relates to central processing unit (CPU) optimization of computer programs, such as video game programs, that are configured for execution on a processor-based system or device, and in particular on a multi-CPU or multi-core system or device.

### BACKGROUND

In computer programming, the term “thread” is short for “thread of execution.” Threads provide a way for a program to split itself into two or more simultaneously (or pseudo-simultaneously) running tasks. Threads are distinguished from traditional operating system processes in that processes are typically independent, carry considerable state information, have separate address spaces, and interact only through system-provided inter-process communication mechanisms. In contrast, threads typically share the state information of a single process, and share memory and other resources directly. Context switching between threads in the same process is typically faster than context switching between processes.

“Multi-threading” is a term used to refer to a programming and execution model that allows multiple threads to exist within the context of a single process, sharing the resources of the process but able to execute independently. On a multi-processor or multi-core system, a multi-threaded program can achieve significantly faster execution by running different program threads on different processors or cores simultaneously. This is because the threads of the program naturally lend themselves to truly concurrent execution.

Many existing video game programs are not multi-threaded. That is to say, when such video game programs are executed, only a single thread is used to execute all the logic, input/output (I/O) and rendering associated with the video game.

Typically, when a video game program is executed on a processor-based system, frames of graphics content associated with the video game are displayed on a screen of a display or display device associated with the system. To render the frames, the video game program places calls to graphics engines such as those associated with Microsoft® DirectX®, OpenGL®, or others, using the appropriate application programming interface (API). The performance of a video game program is typically measured by its frame rate, which is the number of frames of graphics content that are displayed on a screen per second while the video game program is running.

In order to present a frame to the screen, the following major steps may be performed by the executing video game program:

(1) Update World: In this step, the executing video game program determines a status and a position of each object eligible for rendering. This step may include, for example, accounting for the movement of objects such as a player character, one or more computer characters and other objects such as cars, animals or the like. This step may also include, for example, accounting for a change in state of an object, such as determining the strength of a player character in accordance with actions taken by the player character or other characters in the video game. This step may include various other functions depending on the video game program.

(2) Render World: In this step, the executing video game program renders an entire scene by placing calls to a graphics engine using the appropriate API.

(3) Present World: In this step, the executing video game program presents the rendered scene to the screen.

Each of these major steps may consume a relatively large amount of the processing power of the system's central processing unit (CPU).

If the video game has been programmed to execute using only a single thread, all of the above steps must be executed synchronously. In other words, for each frame, the executing video game program must perform the following steps in a serial, non-overlapping fashion: (1) Update World, (2) Render World, (3) Present World, and then (4) Return to (1). In a system that has only one CPU, there is no real disadvantage to using such a single-threaded approach, since only one thread can be executed by the CPU at a time. However, in a system that includes more than one CPU or more than one CPU core, using a multi-threaded implementation of the video game program can significantly benefit the performance of the video game by allowing different tasks to be executed in parallel by the multiple CPUs/cores.

Therefore, it would be beneficial to game performance if existing single-threaded video game programs could be converted into multi-threaded programs. For example, it would be beneficial if multiple threads could be used to execute the Update World phase described above. In accordance with this example, a first thread could be used to render an environment (sky, building, rain and the like) and a second thread could be used to render characters. As another example, it would be beneficial if multiple threads could be used wherein each thread is responsible for a different phase of game execution. In accordance with this example, a first thread could be used to execute the Update World phase while a second thread could be used to execute the Render World phase.

Typically, converting an existing single-threaded video game program into a multi-threaded video game program requires substantially altering or re-writing the source code of the program so that it can support parallel thread execution. This can be expensive and time consuming. Moreover, the party wishing to convert the program needs to acquire, modify and recompile the source code after release. This may not be possible or commercially feasible in all cases. For example, the party wishing to modify the source code in this manner may not have access to the source code. As another example, multiple instances of the game may already have been purchased and installed by multiple end users and one will not be able to necessarily update those instances.

What is needed, then, is a way to improve the performance of a single-threaded video game program running on a multi-CPU or multi-core system using multi-threading techniques without having to alter or re-write the source code associated with the video game program and without having to distribute a new binary version of the video game program.

### BRIEF SUMMARY OF THE INVENTION

The present invention dynamically enhances the performance of an executing computer program by creating one or more additional threads of execution and then intercepting function calls generated by the executing computer program and executing such function calls within one of the one or more additional threads. Each thread may be associated with a different processing resource, thereby allowing for concurrent execution of the multiple threads. The present invention may be used, for example, to improve the performance of a single-threaded computer program, such as a single-threaded video game program, by allowing multi-threaded techniques to be used to execute the computer program even though the computer program was not designed to use such techniques.

In particular, a method for dynamically enhancing the performance of a computer program executing within a first thread is described herein. In accordance with the method, a function call generated by the executing computer program is intercepted. The intercepted function call is then executed within a second thread. The function call may be, for example, one of a graphics function call, an audio function call, or an input/output (I/O) function call.

A system is also described herein. The system includes a first processing resource, a second processing resource, a computer program and a thread creation and management component. The computer program is configured for execution within a first thread associated with either the first processing resource or the second processing resource. The thread creation and management component is configured to intercept a function call generated by the computer program during execution and to execute the intercepted function call within a second thread associated with one of the first processing resource or the second processing resource. The first processing resource may be a first central processing unit (CPU) and the second processing unit may be a second CPU. Alternatively, the first processing resource may be a first CPU core and the second processing unit may be a second CPU core. The thread creation and management component may be configured to intercept, for example, one of a graphics function call, an audio function call, or an I/O function call.

A computer program product is also described herein. The computer program product includes a computer-readable medium having computer program logic recorded thereon for enabling a first processing resource and a second processing resource to enhance the performance of a computer program executing within a first thread. The computer program logic includes first means and second means. The first means enables the first processing resource to intercept a function call generated by the executing computer program. The second means enables the second processing resource to execute the intercepted function call within a second thread. The first means may comprise, for example, means for enabling the first processing resource to intercept one of a graphics function call, an audio function call, or an input/output function call.

An alternative method for dynamically enhancing the performance of a computer program executing within a first thread associated with a first processing resource is also described herein. In accordance with the alternative method, a plurality of additional threads is launched. A function call generated by the executing computer program is then intercepted. The intercepted function call is then selectively assigned to one of the plurality of additional threads for execution (“worker threads”). The function call may be, for example, one of a graphics function call, an audio function call, or an I/O function call.

An alternative system is also described herein. The alternative system includes a plurality of processing resources, a computer program and a thread creation and management component. The computer program is configured for execution within a first thread associated with one of the plurality of processing resources. The thread creation and management component is configured to intercept a function call generated by the computer program during execution and to selectively assign the intercepted function call to one of a plurality of additional threads for execution. The thread creation and management component may configured to intercept, for example, one of a graphics function call, an audio function call, or an I/O function call.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram that depicts software components of an example computer system in accordance with an embodiment of the present invention.

FIG. 2 is an illustration of a single thread used an application program to present graphics content to a display.

FIG. 3 is a block diagram that illustrates the interaction of various components of a computer system when an executing application places function calls to a graphics library.

FIG. 4 is a block diagram that illustrates the interaction of various components of a computer system when implementing a multi-threaded mode of operation in accordance with an embodiment of the present invention.

FIG. 5 depicts the distribution of steps used to present graphics content to a display among a primary and secondary thread in accordance with one embodiment of the present invention.

FIG. 6 depicts the distribution of tasks associated with performing a Render World step among up to N additional threads of execution in accordance with an embodiment of the present invention.

FIG. 7 depicts a flowchart of a general method for dynamic thread creation and management in accordance with an embodiment of the present invention.

FIG. 8 depicts hardware components of an exemplary computer system that may be used to implement an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Example Software Components of a Computer System in Accordance with an Embodiment of the Present Invention

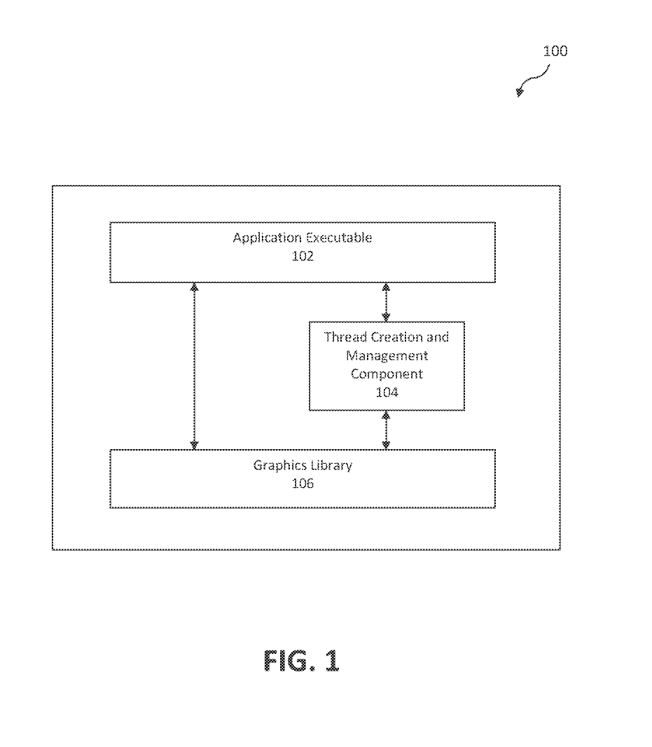

FIG. 1 depicts software components of an example computer system 100 in accordance with an embodiment of the present invention. Computer system 100 may comprise a general-purpose computing device such as a personal computer, an interactive entertainment computer such as a video game console, a mobile device such as a portable video game player, cellular phone or personal digital assistant, or any other device that is capable of executing computer programs and displaying associated graphics content to an end user.

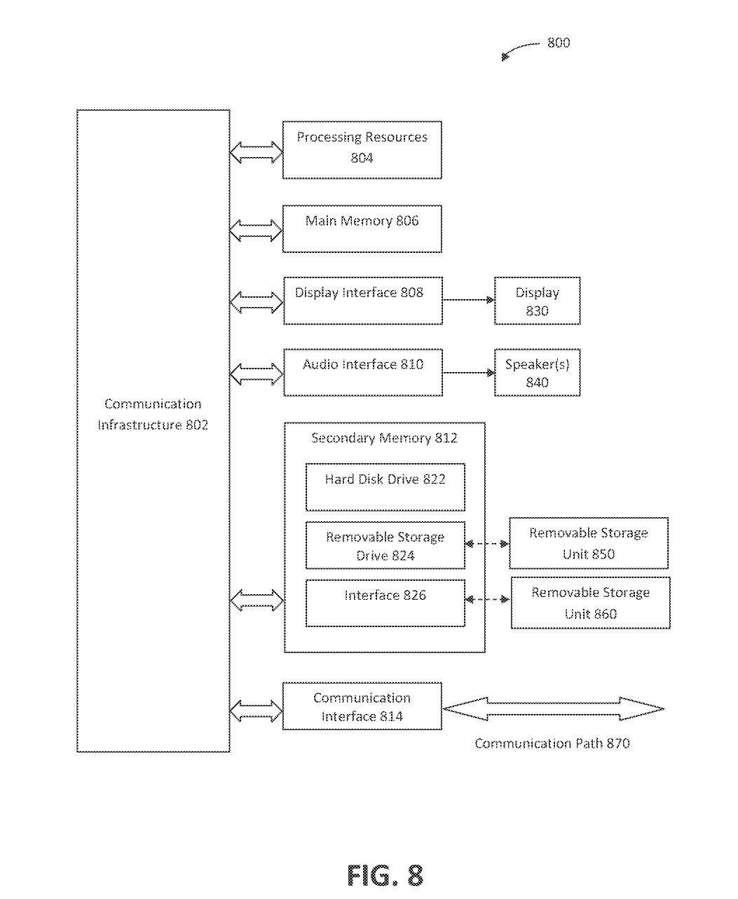

Computer system 100 includes a plurality of processing resources for executing software components. For example, computer system 100 may include a plurality of central processing units (CPUs) or a plurality of CPU cores, each of which may be used to concurrently execute software components of computer system 100. Additional hardware components that may be included in computer system 100 will be described below in reference to FIG. 8.

As shown in FIG. 1, the software components of computer system 100 include an application executable 102, a thread creation and management component 104, and a graphics library 106. As in most conventional computer systems, each of these software components is stored in memory within or accessible to computer system 100 and is configured to be executed by a processing resource of computer system 100. Each of these software components will now be described.

Application executable 102 is any of a wide variety of available computer programs that, when executed by computer system 100, allows a user of computer system 100 to perform a certain function or set of functions. For the purposes of the present description, it will be assumed that application executable 102 is a conventional video game program that allows a user of computer system 100 to play a video game. Accordingly, application executable 102 is programmed to perform a variety of tasks including tasks necessary for presenting frames of game-related graphics content to a display associated with computer system 100. It will be assumed for the purposes of this description that application executable 102 is programmed to use a single thread to perform all tasks necessary to present a frame to the display.

Note that although application executable 102 is described herein as a computer program that allows a user of computer system 100 to play a video game, the present invention is not limited to video game applications. Rather, the present invention may be used in conjunction with any type of application capable of execution on a computer system.

Graphics library 106 is a library of graphics functions that are accessible to application executable 102 during run-time and that assist application executable 102 in rendering game-related graphics content for presentation to the display. Application executable 102 is programmed such that, during execution, it issues function calls to graphics library 106 using a suitable application programming interface (API). Graphics library 106 may comprise, for example, a library of Microsoft® DirectX® or OpenGL® functions. The interaction of application executable 102 with graphics library 106 is well-known in the art.

Thread creation and management component 104 is a software component that is installed on computer system 100 prior to execution of application executable 102. Thread creation and management component 104 may be installed on computer system 100 together with application executable 102, or independent of it. Thread creation and management component 104 is configured to dynamically create one or more new threads during execution of application executable 102. The one or more additional threads are used to perform certain tasks necessary to present a frame to the display that would have otherwise been performed by the single thread used for execution by application executable 102. By creating the additional thread(s), thread creation and management component 104 advantageously allows the tasks necessary to present a frame to the display to be divided and performed in parallel by the multiple processing resources of computer system 100.

Thread creation and management component 104 is depicted in FIG. 1 as residing in between application executable 102 and graphics library 106 and being in communication with both components. This is because thread creation and management component 104 operates in part by intercepting function calls placed by application executable 102 to graphics library 106. This feature of thread creation and management component 104 will be described in more detail herein.

Thread creation and management component 104 essentially enables application executable 102 to take advantage of multi-threading techniques that improve game performance even though application executable 102 has not been programmed to use such multi-threading techniques. The manner in which thread creation and management component 104 achieves this will now be described. However, it will first be helpful to describe a “normal execution” mode of operation in which thread creation and management component 104 is not used and in which application executable 102 is executed using only a single thread.

1. Normal Execution of Application Executable

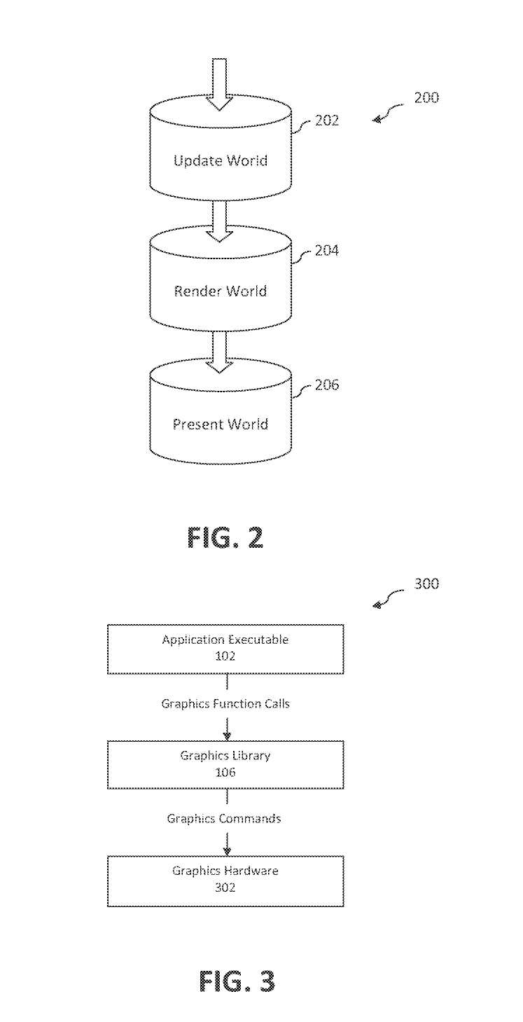

During normal execution, application executable 102 uses a single thread of execution to perform a number of steps necessary for presenting game-related graphics content to a display. This is consistent with the manner in which application executable 102 is programmed. One example of such a thread is depicted in FIG. 2, and is denoted thread 200.

As shown in FIG. 2, steps performed by application executable 102 using thread 200 include an Update World step 202, a Render World step 204, and a Present World step 206. These steps will now be described. However, these steps are described by way of example only and are not intended to limit the present invention. As will be appreciated by persons skilled in the relevant art(s) based on the teaching provided herein, the invention is equally applicable to other computer programs that perform steps other than those described here.

In the Update World step 202, application executable 102 determines a status and a position of each object eligible for rendering. This step may include, for example, accounting for the movement of objects such as a player character, one or more computer characters and other objects such as cars, animals or the like. This step may also include, for example, accounting for a change in state of an object, such as determining the strength of a player character in accordance with actions taken by the player character or other characters in the video game. This step may include various other functions depending on the video game program.

In the Render World step 204, application executable 102 renders an entire scene by placing calls to graphics library 106 using the appropriate API. FIG. 3 provides an illustration 300 of the interaction of various components of computer system 100 when performing this step. As shown in FIG. 3, during the Render World step 204, application executable 102 places function calls to graphics library 106 in a well-known manner. In the same processing context, graphics commands associated with the function calls are generated in graphics library 106 and transferred to graphics hardware 302 via a device driver associated with graphics hardware 302 (not shown in FIG. 3). Graphics hardware 302 may comprise any hardware device that can be used to generate and output images to a display associated with computer system 100 including but not limited to any of a variety of well-known graphics cards or chipsets.

In the Present World step 206, application executable 102 presents the rendered scene to the screen. This step may also include the placement of function calls to graphics library 106 by application executable 102 and the transfer of associated graphics commands from graphics library 106 to graphics hardware 302.

Each of steps 202, 204 and 206 may consume a relatively large amount of the processing resources of computer system 100.

Because application executable 102 has been programmed to execute using only a single thread, all of the above steps must be executed synchronously by computer system 100. In other words, for each frame, application executable 102 must perform the following steps in a serial, non-overlapping fashion: Update World 202, Render World 204, Present World 206, and then Return to Update World 202. In a system that has only one CPU, there is no real disadvantage to using such a single-threaded implementation, since only one thread can be executed by the CPU at a time. However, in a system like system 100 that includes more than one CPU or more than one CPU core, using a multi-threaded implementation of the application program would significantly benefit the performance of the application by allowing different tasks to be executed in parallel by the multiple CPUs/cores. Because application executable 102 has been programmed only to use a single thread of execution, it cannot take advantage of the multiple CPUs/cores in this fashion.

2. Multi-Threaded Execution of Application Executable in Accordance with an Embodiment of the Present Invention

In accordance with an embodiment of the present invention, thread creation and management component 104 operates during the execution of application executable 102 to create a different thread of execution other than that normally associated with application executable 102. Thread creation and management component 104 further operates during the execution of application executable 102 to intercept function calls placed by application executable 102 to graphics library 106. These intercepted function calls are then implemented within the newly-created thread of execution. This allows for multi-threaded execution of certain tasks of application executable 102 even though application executable 102 was not programmed to allow such multi-threaded execution.

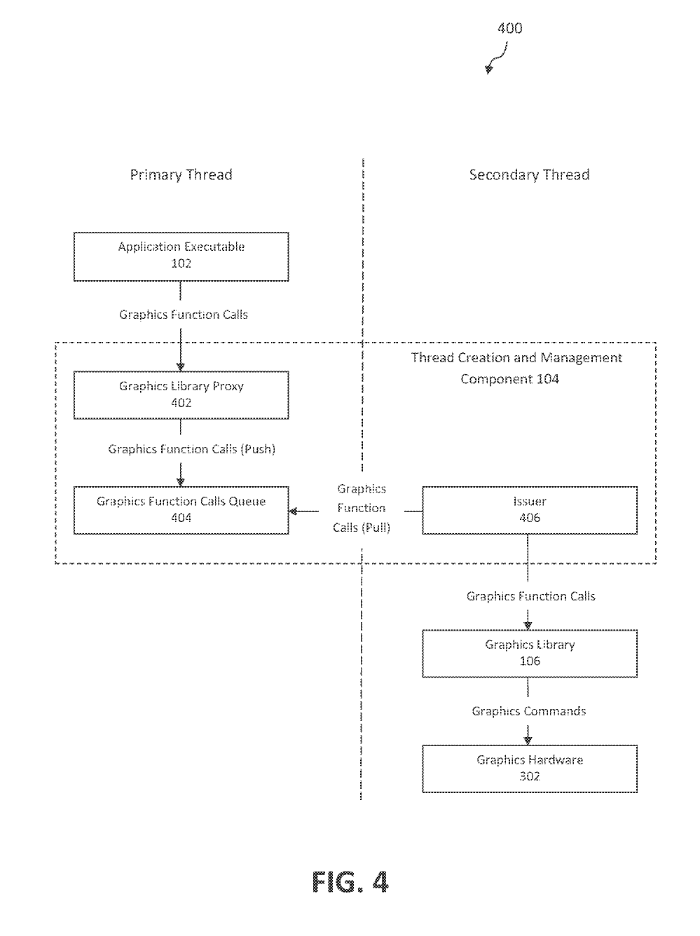

FIG. 4 provides an illustration 400 of the interaction of various components of computer system 100 when implementing this multi-threaded mode of operation in accordance with one implementation of the present invention. As shown in FIG. 4, thread creation and management component 104 includes a graphics library proxy 402, a graphics function calls queue 404, and an issuer 406. The function of each of these sub-components of thread creation and management component 104 will be described in more detail herein.

During execution, application executable 102 place function calls to graphics library 106 in a well-known manner to render graphics content and present it to a display associated with computer system 100. These function calls are intercepted by graphics library proxy 402 and are pushed into graphics function calls queue 404. Each function call is stored in queue 404 along with associated parameters and context. The combination of a function call and its associated parameters and context may be termed an “issuer object.”

The foregoing interactions take place in a first thread of execution (referred to as the “primary thread” in FIG. 4) normally associated with application executable 102. A second thread of execution (referred to as the “secondary thread” in FIG. 4) is created by graphics library proxy 402 upon intercepting one or more function calls that are placed by application executable 102 to initialize graphics library 106 and/or graphics hardware 302.

An issuer 406 running in the secondary thread pulls graphic function calls from queue 404 and issues them to graphics library 106 as if they were issued by application executable 102. Graphics library 106 processes the function calls to produce corresponding graphics commands and transfers the graphics commands to graphics hardware 302 via a device driver in a well-known manner.

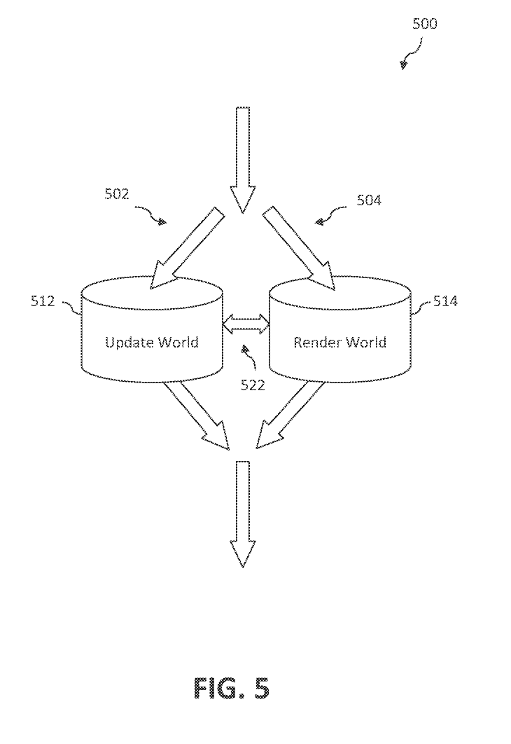

By operating in the foregoing fashion, the components of computer system 100 shown in FIG. 4 allow the functions performed by application executable 102 to be executed in a multi-threaded fashion. FIG. 5 provides an illustration 500 of how steps necessary to present game-related graphics content to a display may be distributed among a primary and secondary thread in accordance with one embodiment of the present invention. As shown in FIG. 5, tasks associated with an Update World step 512 can be processed in parallel with tasks associated with a Render World step 514 because Update World step 512 is executed in a primary thread 502 executing on a first processing resource while Render World step 514 is executed in a secondary thread 504 running on a second processing resource. For example, while Render World step 514 is rendering graphics content associated with a first frame, Update World step 512 can calculate the status and position of objects for the rendering of a second frame that is subsequent to the first frame. To handle synchronous function calls, there may be some limited interaction between the Render World step 514 and the Update World step 512, as denoted by bi-directional arrow 522.

Although all the tasks associated with Render World step 514 are shown as executing in secondary thread 504 in FIG. 5, persons skilled in the relevant art(s) will readily appreciate that a portion of the tasks associated Render World step 514 may also be performed in primary thread 502. The number and types of tasks that are delegated to secondary thread 504 can be controlled by proper configuration of thread creation and management component 104 and/or by queue 404. For example, thread creation and management component 104 may be programmed to select only certain graphics function calls for interception and queuing for execution in secondary thread 504.

Example implementation details associated with the components shown in FIG. 4 will now be provided. First, a discussion of the manner in which graphics library proxy 402 operates to intercept function calls placed by application executable 102 will be provided. Then, a discussion of the manner in which thread creation and management component 104 returns results or other information to application executable 102 responsive to receiving function calls that require the return of such results or other information will be provided.

a. Interception of Graphics Function Calls

As described above, graphics library proxy 402 is configured to intercept graphics function calls generated by application executable 102 that are intended for graphics library 106. This interception may be achieved by emulating graphics library 106, or a portion thereof. By using such emulation, certain function calls issued by application executable 102 are received by graphics library proxy 402 rather than graphics library 106.

Depending on the operating system, emulating graphics library 106 can be achieved in various ways. One method for emulating a graphics library is file replacement. For example, since both DirectX® and OpenGL® APIs are dynamically loaded from a file, emulation can be achieved by simply replacing the pertinent file (for example, OpenGL.dll for OpenGL® and d3dX.dll for DirectX® where X is the DirectX® version). Alternatively, the DLL can be replaced with a stub DLL having a similar interface that implements a pass-through call to the original DLL for all functions but the functions to be intercepted.

An alternative method for intercepting function calls to graphics library 106 is to use the Detours hooking library published by Microsoft® Corporation of Redmond, Wash. Hooking may also be implemented at the kernel level. Kernel-level hooking may include the use of an operating system (OS) ready hook that generates a notification when a particular API is called. Another technique is to replace existing OS routines by changing a pointer in an OS API table to a hook routine pointer, and optionally chaining the call to the original OS routine before and/or after the hook logic execution. Another possible method is an API-based hooking technique that injects a DLL into any process that is being loaded by setting a global system hook or by setting a registry key to load such a DLL. Such injection is performed only to have the hook function running in the address space. While the OS loads such a DLL, a DLL initialization code changes a desired DLL dispatch table. Changing the table causes a pointer to the original API implementation to point to the interception DLL implementation for a desired API, thus hooking the API. Note that the above-describing hooking techniques are presented by way of example and are not intended to limit the present invention. Other methods and tools for intercepting function calls to graphics library 106 are known to persons skilled in the relevant art(s).

b. Returning of Results or Other Information Associated with Graphics Function Calls

For certain graphics function calls, application executable 102 may expect a result or other information to be returned from graphics library 106. For example, application executable 102 may expect to receive a message indicating whether or not a graphics function call has completed successfully. Alternatively or additionally, application executable 102 may expect to receive a real value such as, for example, a device context on device creation. In some instances, the execution of application executable 102 may be stalled until such time as the result or other information has been returned from graphics library 106.

One of the goals of using thread creation and management component 104 is to allow tasks performed in the primary thread of execution associated with application executable 102 to be performed independently and in parallel with tasks performed in the secondary thread of execution created by thread creation and management component 104. Therefore, it is undesirable to require that all results or other information to be returned in response to the issuance of certain graphics function calls be passed from graphics library 106 (which is being used in the secondary thread of execution) to application executable 102 (which is running in the primary thread of execution).

In order to address this, in an embodiment of the present invention, where a graphics function call requires only the return of a message indicating whether or not the function call has completed successfully, graphics library proxy 402 will return a message indicating that the function call has completed successfully even though the graphics function call has only been placed in graphics function call queue 404. In this instance, graphics library proxy 402 will assume that the graphics function call will succeed when issued by issuer 406 and processed by graphics library 106 in the secondary thread. By simulating the return of an immediate result in this fashion, an embodiment of the present invention advantageously decouples the processing performed in the primary and the secondary thread and enables concurrent execution by the two threads.

If, however, a graphics function call requires the return of a real value, then the graphics function call and an associated results structure will remain in queue 404 until such time as issuer 406 determines that the graphics function call has actually completed. Once the graphics function call completed and the real value has been returned, issuer 406 will place the real value in the results structure associated with the graphics function call. Issuer 406 will then signal the primary thread about the completion of the graphics function call and the primary thread provides the results structure to application executable 102 responsive to receipt of this signal.

In many implementations, only a small minority of the graphics function calls issued by application executable 102 will require the return of a real value. Thus, in accordance with the foregoing approach, only a small number of graphics function calls will require any sort of synchronization between the primary and secondary threads and, for the most part, concurrent execution will be possible.

For example, below is a typical sequence of Microsoft® DirectX® commands that might be issued by application executable 102:

### Direct3DVertexBuffer9Proxy::Lock( )

### IDirect3DVertexBuffer9Proxy::Unlock( )

### IDirect3DDevice9Proxy::SetStreamSource( )

### IDirect3DDevice9Proxy::SetFVF( )

### IDirect3DDevice9Proxy::SetTexture( )

### IDirect3DDevice9Proxy::SetTextureStageState( )

### IDirect3DDevice9Proxy::SetTextureStageState( )

### IDirect3DDevice9Proxy::SetSamplerState( )

### IDirect3DDevice9Proxy::SetSamplerState( )

### IDirect3DDevice9Proxy::SetRenderState( )

### IDirect3DDevice9Proxy::SetRenderState( )

### IDirect3DDevice9Proxy::SetRenderState( )

### IDirect3DDevice9Proxy::DrawPrimitive( )

### IDirect3DDevice9Proxy::SetSamplerState( )

### IDirect3DDevice9Proxy::SetSamplerState( )

### IDirect3DDevice9Proxy::SetSamplerState( )

### IDirect3DDevice9Proxy::SetSamplerState( )

### IDirect3DDevice9Proxy::SetTransform( )

### IDirect3DDevice9Proxy::SetTransform( )

### IDirect3DDevice9Proxy::SetRenderState( )

### IDirect3DDevice9Proxy::SetRenderState( )

### IDirect3DDevice9Proxy::SetRenderState( )

### IDirect3DDevice9Proxy::SetRenderState( )

### IDirect3DDevice9Proxy::SetTransform( )

### IDirect3DDevice9Proxy::SetRenderState( )

### IDirect3DDevice9Proxy::SetRenderState( )

### IDirect3DDevice9Proxy::SetRenderState( )

### IDirect3 DVertexBuffer9Proxy::Lock( )

### IDirect3DVertexBuffer9Proxy::Unlock( )

### IDirect3DDevice9Proxy::SetStreamSource( )

### IDirect3DDevice9Proxy::SetFVF( )

### IDirect3DDevice9Proxy::SetTexture( )

### IDirect3DDevice9Proxy::SetTextureStageState( )

### IDirect3DDevice9Proxy::SetRenderState( )

### IDirect3DDevice9Proxy::SetRenderState( )

### IDirect3DDevice9Proxy::DrawPrimitive( )

### IDirect3DDevice9Proxy::SetRenderState( )

### IDirect3DDevice9Proxy::SetRenderState( )

### IDirect3DDevice9Proxy::SetRenderState( )

### IDirect3DDevice9Proxy::SetTransform( )

### IDirect3DDevice9Proxy::SetRenderState( )

### IDirect3DDevice9Proxy::SetRenderState( )

In the foregoing stream of commands, the only functions that are synchronous functions are Lock( ) and Unlock( ). This means that the primary thread associated with application executable 102 will have to wait until those functions are pulled from queue 404, executed by the secondary thread, and a result returned. The rest of the functions can be executed by the secondary thread(s) while the primary thread is executing on another processing resource.

### B. Alternative Implementations in Accordance with an Embodiment of the Present Invention

The foregoing implementation of computer system 100 has been presented by way of example only and is not limited to the present invention. Persons skilled in the relevant art(s) will readily appreciate that the present invention may be extended in a variety of ways that are not described above in reference to the specific implementation described in reference to FIGS. 1 through 5.

For example, although the implementation of computer system 100 described above describes creating only a single secondary thread of execution, persons skilled in the art will readily appreciate that any number of additional threads of execution may be created by thread creation and management component 104 to facilitate further parallel processing by the processing resources within computer system 100.

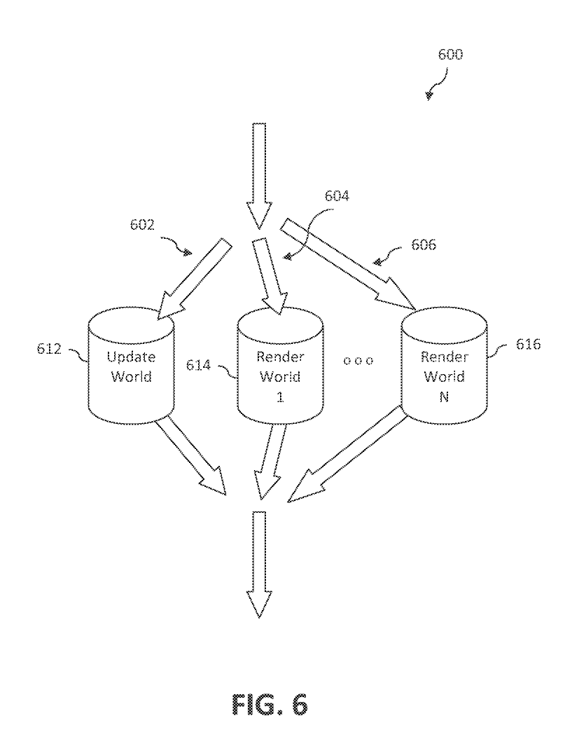

For example, as shown in FIG. 6, thread creation and management component 104 may create up to N additional threads of execution, each of which is configured to execute a subset of the tasks associated with performing a Render World step. Thus, while an Update World step 612 is being performed by a primary thread 602 executing on a first processing resource of computer system 100, the Render World step is being performed by N Render World processes running on N additional threads, each associated with one of N additional processing resources of computer system 100. By way of example, FIG. 6 shows a first additional Render World Process 614 (denoted “Render World 1”) and a last additional Render World process 616 (denoted “Render World N”).

Additionally, the present invention is not limited to using a single issuer 406 as shown in FIG. 4, but may include a plurality of issuers. In such an implementation, queue 404 is in communication with each of the issuers to ensure that when a synchronous command appears, all issuers working from the same queue are synchronized. Furthermore, the present invention is not limited to a single queue 404 as shown in FIG. 4, but can also include a plurality of queues. Each of the plurality of queues may be dedicated to a specific type of task. For example, one queue may be used to hold graphics commands, one queue may be used to hold audio commands, and so forth.

Furthermore, the present invention is not limited to intercepting graphics function calls but can advantageously be used to intercept any types of function calls such as audio function calls and input/output (I/O) function calls issued by application executable 102 via an API. By intercepting these function calls and simulating the return of an immediate result, thread creation and management component 104 can actually implement the function calls in one or more newly-created threads while the primary thread originally associated with the application executable 102 is still running.

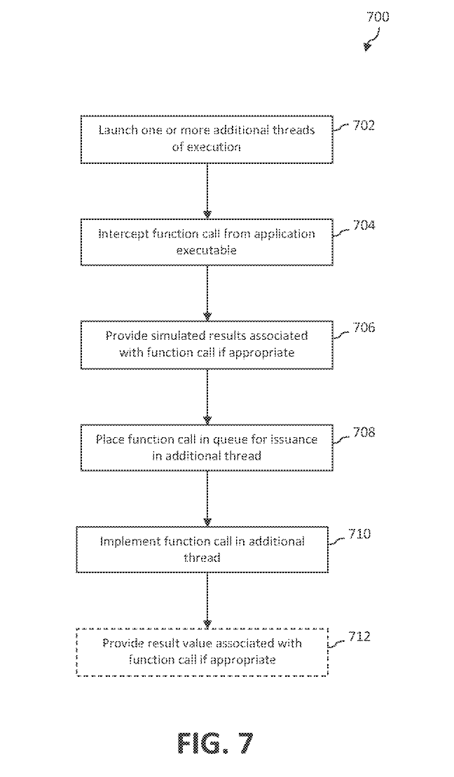

FIG. 7 depicts a flowchart 700 of this general method. As shown in FIG. 7, the method of flowchart 700 begins at step 702 in which a thread creation and management component launches one or more additional threads of execution in addition to a primary thread associated with an application executable. The primary thread may be executed on a first processing resource, such as a first CPU or core, while the additional threads may be executed on respective additional processing resources, such as respective additional CPUs or cores.

At step 704, the thread creation and management component intercepts a function call issued by the application executable. The function call may be a graphics function call, an audio function call, an I/O function call, or some other type of function call, depending upon the implementation.

At step 706, the thread creation and management component provides simulated results associated with function call to the application executable if appropriate. This may occur, for example, where the application executable expects only a message to be returned indicating whether the execution of the function call was successful or not. In this instance, the thread creation and management component provides a message indicating that the function call was executed successfully, even though the function call has not yet been executed. This facilitates concurrent execution of the different threads by the different processing resources.

At step 708, the thread creation and management component places the function call in a queue for subsequent issuance in one of the one or more additional threads. The function call may be stored in the queue along with associated parameters and/or context, as well as with an associated results structure when appropriate.

At step 710, an issuer within the thread creation and management component issues the function call from the queue for execution by one of the one or more additional threads.

At optional step 712, the issuer provides a result value associated with the function call within a results structure stored with the function call in the queue when appropriate. For example, there are certain function calls for which the application executable will expect a real value to be returned after the function call is completed. Step 712 need only be performed for such function calls. During step 712, the issuer provides the real value within the results structure and then signals the primary thread of execution that the real value can be returned to the application executable.

It should be noted that although various implementations of the present invention described herein refer to a video game program or executable, the present invention is not limited to use with video game programs or executables, but can also be used to improve the performance of other types of computer programs. The present invention facilitates this by allowing one or more additional threads of execution to be used to perform processing tasks associated with the computer program. For example, the present invention can be used to allow a computer program designed to use a single thread for performing processing tasks to use multiple threads to perform the same processing tasks in parallel using multiple processing resources. Likewise, the present invention can be used to allow a computer program designed to use multiple threads executing on multiple processing resources for performing processing tasks to use an even greater number of threads to perform the same processing tasks in parallel using an even greater number of processing resources.

### D. Example Hardware Components of a Computer System in Accordance with an Embodiment of the Present Invention

FIG. 8 depicts example hardware components of a computer system 800 that may be used to implement the present invention. Computer system 800 may comprise a general-purpose computing device such as a personal computer, an interactive entertainment computer such as a video game console, a mobile device such as a portable video game player, cellular phone or personal digital assistant, or any other device that is capable of executing computer programs.

As shown in FIG. 8, example computer system 800 includes processing resources 804 for executing software routines. In particular, computer system 800 includes a plurality of processing resources such as a plurality of CPUs or a plurality of CPU cores, each of which may be used to concurrently execute software routines. Processing resources 804 are connected to a communication infrastructure 802 for communication with other components of computer system 800. Communication infrastructure 802 may comprise, for example, a communications bus, cross-bar, or network.

Computer system 800 further includes a main memory 806, such as a random access memory (RAM), and possibly a secondary memory 812. Secondary memory 812 may include, for example, a hard disk drive 822 and/or a removable storage drive 824, which may comprise a floppy disk drive, a magnetic tape drive, an optical disk drive, or the like. Removable storage drive 824 reads from and/or writes to a removable storage unit 850 in a well known manner. Removable storage unit 850 may comprise a floppy disk, magnetic tape, optical disk, or the like, which is read by and written to by removable storage drive 824. As will be appreciated by persons skilled in the relevant art(s), removable storage unit 850 includes a computer usable storage medium having stored therein computer software and/or data.

In an alternative implementation, secondary memory 812 may include other similar means for allowing computer programs or other instructions to be loaded into computer system 800. Such means can include, for example, a removable storage unit 860 and an interface 826. Examples of a removable storage unit 860 and interface 826 include a program cartridge and cartridge interface (such as that found in video game console devices), a removable memory chip (such as an EPROM or PROM) and associated socket, and other removable storage units 860 and interfaces 826 which allow software and data to be transferred from the removable storage unit 860 to computer system 800.

Computer system 800 may also include at least one communication interface 814. Communication interface 814 allows software and data to be transferred between computer system 800 and external devices via a communication path 870. In particular, communication interface 814 permits data to be transferred between computer system 800 and a data communication network, such as a public data or private data communication network. Examples of communication interface 814 can include a modem, a network interface (such as Ethernet card), a communication port, and the like. Software and data transferred via communication interface 814 are in the form of signals which can be electronic, electromagnetic, optical or other signals capable of being received by communication interface 814. These signals are provided to the communication interface via communication path 870.

As shown in FIG. 8, computer system 800 may further include a display interface 808 which performs operations for rendering images to an associated display 830 and may further include an audio interface 810 for performing operations for playing audio content via associated speaker(s) 840.

As used herein, the term “computer program product” may refer, in part, to removable storage unit 850, removable storage unit 860, a hard disk installed in hard disk drive 822, or a carrier wave carrying software over communication path 870 (wireless link or cable) to communication interface 814. A computer useable medium can include magnetic media, optical media, or other recordable media, or media that transmits a carrier wave or other signal. These computer program products are means for providing software to computer system 800.

Computer programs (also called computer control logic) are stored in main memory 806 and/or secondary memory 812. Computer programs can also be received via communication interface 814. Such computer programs, when executed, enable the computer system 800 to perform one or more features of the present invention as discussed herein. In particular, the computer programs, when executed, enable the processing resources 804 to perform features of the present invention. Accordingly, such computer programs represent controllers of the computer system 800.

Software for implementing the present invention may be stored in a computer program product and loaded into computer system 800 using removable storage drive 824, hard disk drive 822, or interface 826. Alternatively, the computer program product may be downloaded to computer system 800 over communications path 870. The software, when executed by processing resources 804, causes the processor 804 to perform functions of the invention as described herein.

### E. CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for dynamically enhancing the performance of a computer program executing within a first thread, comprising:
intercepting a function call generated by the executing computer program; and
executing the intercepted function call within a second thread;
wherein such interception and execution is performed without altering the source code or binary files of the computer program.

2. The method of claim 1, wherein intercepting a function call generated by the executing computer program comprises:
intercepting one of a graphics function call, an audio function call, or an input/output function call.

3. The method of claim 1, further comprising:
initiating the second thread responsive to intercepting at least one prior function call generated by the executing computer program.

4. The method of claim 1, further comprising:
returning a message to the executing computer program indicating that the function call has completed successfully responsive to intercepting the function call.

5. The method of claim 1, further comprising:
storing the intercepted function call in a queue; and
issuing the intercepted function call from the queue for execution within the second thread.

6. The method of claim 5, wherein storing the intercepted function call in a queue comprises storing the intercepted function call and a results structure associated with the intercepted function call in the queue, the method further comprising:
receiving a real value responsive to execution of the intercepted function call;
storing the real value in the results structure associated with the intercepted function call; and
signaling the first thread that the real value has been stored in the results structure associated with the intercepted function call.

7. A system, comprising:
a first processing resource;
a second processing resource;
a computer program configured for execution within a first thread associated with either the first processing resource or the second processing resource;
a thread creation and management component configured to intercept a function call generated by the computer program during execution and to execute the intercepted function call within a second thread associated with one of the first processing resource or the second processing resource.

8. The system of claim 7, wherein the first processing resource is a first central processing unit (CPU) and the second processing unit is a second CPU.

9. The system of claim 7, wherein the first processing resource is a first central processing unit (CPU) core and the second processing unit is a second CPU core.

10. The system of claim 7, wherein the thread creation and management component is configured to intercept one of a graphics function call, an audio function call, or an input/output function call.

11. The system of claim 7, wherein the thread creation and management component is further configured to initiate the second thread responsive to intercepting at least one function call generated by the computer program during execution.

12. The system of claim 7, wherein the thread creation and management component is further configured to return a message to the executing computer program indicating that the function call has completed successfully responsive to intercepting the function call.

13. The system of claim 7, wherein the thread creation and management component is further configured to store the intercepted function call in a queue and issue the intercepted function call from the queue for execution within the second thread.

14. The system of claim 13, wherein the thread creation and management component is configured to store the intercepted function call and a results structure associated with the intercepted function call in the queue, and wherein the thread creation and management component is further configured to receive a real value responsive to execution of the intercepted function call, to store the real value in the results structure associated with the intercepted function call, and to signal the first thread that the real value has been stored in the results structure associated with the function call.

15. A computer program product comprising a computer-readable medium having computer program logic recorded thereon for enabling a first processing resource and a second processing resource to enhance the performance of a computer program executing within a first thread associated with the first processing resource, the computer program logic comprising:
first means for enabling the first processing resource to intercept a function call generated by the executing computer program; and
second means for enabling the second processing resource to execute the intercepted function call within a second thread.

16. The computer program product of claim 15, wherein the first means comprises:
means for enabling the first processing resource to intercept one of a graphics function call, an audio function call, or an input/output function call.

17. The computer program product of claim 15, wherein the computer program logic further comprises:
means for enabling the first processing resource to initiate the second thread responsive to intercepting at least one prior function call generated by the executing computer program.

18. The computer program product of claim 15, wherein the computer program logic further comprises:
means for enabling the first processing resource to return a message to the executing computer program indicating that the function call has completed successfully responsive to intercepting the function call.

19. The computer program product of claim 15, wherein the computer program logic further comprises:
means for enabling the first processing resource to store the intercepted function call in a queue; and
means for enabling the second processing resource to issue the intercepted function call from the queue for execution within the second thread.

20. The computer program product of claim 19, wherein the means for enabling the first processing resource to store the intercepted function call in a queue comprises means for enabling the first processing resource to store the intercepted function call and a results structure associated with the intercepted function call in the queue, and wherein the computer program logic further comprises:
means for enabling the second processing resource to receive a real value responsive to execution of the intercepted function call;
means for enabling the second processing resource to store the real value in the results structure associated with the intercepted function call; and
means for enabling the second processing resource to signal the first thread that the real value has been stored in the results structure associated with the intercepted function call.

21. A method for dynamically enhancing the performance of a computer program executing within a first thread associated with a first processing resource, comprising:
launching a plurality of additional threads;
intercepting a function call generated by the executing computer program; and
selectively assigning the intercepted function call to one of the plurality of additional threads for execution.

22. The method of claim 21, wherein intercepting a function call generated by the executing computer program comprises:
intercepting one of a graphics function call, an audio function call, or an input/output function call.

23. A system, comprising:
a plurality of processing resources;
a computer program configured for execution within a first thread associated with one of the plurality of processing resources;
a thread creation and management component configured to intercept a function call generated by the computer program during execution and to selectively assign the intercepted function call to one of a plurality of additional threads for execution.

24. The system of claim 23, wherein the thread creation and management component is configured to intercept one of a graphics function call, an audio function call, or an input/output function call.
